(19) United States
(12) Patent Application Publication
(10) Pub. No.: US 2026/0169556 A1
(43) Pub. Date: Jun. 18, 2026

(54) SYSTEM AND METHOD FOR CONTROLLING VIRTUAL OBJECT

(71) Applicants: HYUNDAI MOTOR COMPANY, Seoul (KR); Kia Corporation, Seoul (KR)

(72) Inventors: Jongho SHIN, Hwaseong-si (KR); Sangok BYUN, Hwaseong-si (KR)

(21) Appl. No.: 19/406,493

(22) Filed: Dec. 2, 2025

(30) Foreign Application Priority Data
Dec. 12, 2024 (KR) 10-2024-0185062

(51) Int. Cl. G06F 3/01; G06F 3/0482; G06F 3/04845; G06F 3/0486

(52) U.S. Cl. CPC G06F 3/013; G06F 3/017; G06F 3/0482; G06F 3/04845; G06F 3/0486

(57) ABSTRACT

A virtual object control system includes: a user terminal configured to execute an eXtended reality (XR) application and a head-mounted display (HMD) configured to receive, an XR content via the XR application, detect a user interaction, provide the detected user interaction to the user terminal, and display the XR content and the user interaction within a user's field of view. The XR application is configured to (i) recognize a gaze gesture from the pupil movement and a Fleming gesture, an arm rotation gesture, a fist gesture, and a finger gesture from the hand motion and (ii) set a gesture command for controlling a virtual object on the XR content based on transition of a window view, an immersive view, and a fully immersive view. The gesture command is executed by the XR application to move the virtual object, rotate the virtual object, or change the size of the virtual object.

### CROSS-REFERENCE TO RELATED APPLICATION

This application claims priority to and the benefit of Korean Patent Application No. 10-2024-0185062 filed with the Korean Intellectual Property Office on Dec. 12, 2024, the entire contents of which are incorporated herein by reference.

### TECHNICAL FIELD

The present disclosure relates to a virtual object control system and method, and more specifically, to a virtual object control apparatus that variably adjusts an action of picking up an anchor collider virtual object based on a user's eye movement and hand motion in an eXtended reality (XR) virtual environment according to the user's perspective, and provides a function of inputting and outputting the same to virtual environment contents.

### BACKGROUND

The eXtended reality (XR) market has been in existence for some time, but it began to experience rapid development starting in 2020. This growth is expected to accelerate further, and competition within the market is likely to intensify following the release of various head-mounted display (HMD) devices beginning in 2023. Traditionally, augmented reality (AR) applications have been developed using technologies that recognize specific physical reference points and overlay virtual information accordingly. In contrast, simulation technologies have primarily focused on creating virtual environments to verify design and performance aspects of systems.

Recently, AR and simulation technologies have begun to converge, giving rise to fusion technologies that allow simulations to be reviewed in real-world environments at actual size. This emerging approach is gaining attention, particularly as the AR industry shifts toward passthrough type HMD-based mixed reality user experience (MR UX) that blend real and virtual content. These MR technologies aim to provide an integrated experience by enabling simultaneous use of virtual information and real information in actual environments.

In the field of manufacturing simulation, such technologies are especially valuable for identifying issues early in the design phase, improving design flaws, and reducing overall costs. However, current practices still rely heavily on office-based simulations, with results later reviewed on-site. This workflow requires projects to be rebuilt and re-evaluated to address any issues discovered in the field, leading to inefficiencies. As a result, even minor modifications can become time-consuming and costly, ultimately hindering productivity and operational efficiency.

### SUMMARY

The present disclosure is directed to a virtual object control system and method that can provide an environment in which a design change and review can be made immediately on site by utilizing biometric tracking information while wearing a head-mounted display (HMD).

According to an aspect of the present disclosure, a virtual object control system can include a user terminal configured to execute an eXtended reality (XR) application, and a head-mounted display (HMD). The HMD can be configured to receive, from the user terminal, an XR content via the XR application, detect a user interaction including at least one of a pupil movement, a hand motion, or a voice command, provide, to the user terminal, the detected user interaction, and display the XR content and the user interaction within a user's field of view. The XR application can be configured to recognize (i) a gaze gesture from the pupil movement and (ii) a Fleming gesture, an arm rotation gesture, a fist gesture, and a finger gesture from the hand motion, and set a gesture command for controlling a virtual object on the XR content based on transition of a window view, an immersive view, and a fully immersive view. The gesture command can be executed by the XR application to move the virtual object, rotate the virtual object, or change the size of the virtual object.

In some implementations, the XR application can be configured to, based on the gaze gesture being recognized for a predetermined time period for the virtual object in the gesture command, perform displaying of (i) emphasizing the virtual objected selected by the gaze gesture and (ii) a user interface configured to receive a selected function for controlling the virtual object on the XR context, and the user interface can include a first sub-user interface configured to receive a selected function to move the virtual object, a second sub-user interface configured to receive a selected function to rotate the virtual object, and a third sub-user interface configured to receive a selected function to change a size of the virtual object.

In some examples, the XR application can be configured to, based on the Fleming gesture being recognized in the gesture command after the first sub-user interface is selected in the window view, distinguish a left finger and a right finger of the hand in the Fleming gesture, display a movement axis for movement of the virtual object on the XR content, and set a movement mode of the virtual object to an axis-fixed movement mode, and the XR application can be configured to, based on the fist gesture being recognized in the gesture command after the first sub-user interface is selected, set the movement mode of the virtual object to an autonomous movement mode. In some examples, the XR application can be configured to, based on the arm rotation gesture being recognized after the Fleming gesture is recognized in the axis-fixed movement mode, move the virtual object along the axis of movement by a distance determined by a degree of rotation, and the XR application can be configured to, based on the fist gesture or the finger gesture being recognized, terminate the movement of the virtual object.

In some examples, the XR application can be configured to, based on the Fleming gesture and the fist gesture being recognized together after the arm rotation gesture is recognized in the axis-fixed movement mode, move the virtual object along the axis of movement by a distance determined according to the fist gesture. In some implementations, the XR application can be configured to, based on the Fleming gesture being recognized in the gesture command after the second sub-user interface is selected in the window view, distinguish a left finger and a right finger of the hand in the gesture command, display a rotation axis for rotation of the virtual object on the XR content, and set a rotation mode of the virtual object to an axis-fixed rotation mode, and the XR application can be configured to, based on the fist gesture being recognized in the gesture command after the first sub-user interface is selected, set a rotation mode of the virtual object to an autonomous rotation mode.

In some examples, the XR application can be configured to, based on the arm rotation gesture being recognized after the Fleming gesture is recognized in the axis-fixed rotation mode, rotate the virtual object along the rotation axis by a distance determined according to a degree of arm rotation, and the XR application can be configured to, based on the fist gesture or the finger gesture being recognized, terminate the rotation of the virtual object.

In some implementations, the XR application can be configured to recognize a picking gesture and a drop gesture from the hand motion, the XR application can be configured to, based on the picking gesture being recognized in the gesture command after the first sub-user interface is selected in the immersive view, display an expected drop point on the XR content using a virtual grid, and the XR application can be configured to, based on the drop gesture being recognized after the picking gesture is recognized, move the virtual object to drop the virtual object on the expected drop point. In some examples, the XR application can be configured to, based on the virtual object being moved to be dropped on the expected drop point, perform a snap for a designated object in a predetermined snap region when a position of the virtual object after the movement is included in the predetermined snap region.

In some implementations, the XR application can be configured to recognize an axis rotation gesture from the hand motion, and the XR application can be configured to, based on the Fleming gesture being recognized in the gesture command after the second sub-user interface is selected in the immersive view, distinguish a left finger and a right finger of the hand in the Fleming gesture and display a rotation axis for rotation of the virtual object on the XR content, and the XR application can be configured to, based on the axis rotation gesture being recognized after the Fleming gesture is recognized, rotate the virtual object on the rotation axis to correspond to the axis rotation. In some examples, the XR application can be configured to recognize a finger pinch gesture or a two-hand pinch gesture from the hand motion, and the XR application can be configured to, based on the finger pinch gesture or the two-hand pinch gesture being recognized in the gesture command after the third sub-user interface is selected in the immersive view, change a size of the virtual object.

In some implementations, the XR application can be configured to recognize a push wall gesture or a pull rope gesture from the hand motion, and the XR application can be configured to, based on the push wall gesture or the pull rope gesture being recognized in the gesture command after the first sub-user interface or the second sub-user interface is selected in the fully immersive view, move or rotate the virtual object. In some implementations, the XR application can be configured to recognize a compression gesture or an expansion gesture from the hand motion, and the XR application can be configured to, based on the compression gesture or the expansion gesture being recognized after the third-sub user interface is selected in the fully immersive view, change a size of the virtual object.

According to another aspect of the present disclosure, a virtual object control method can be performed by a user terminal, which is configured to execute an eXtended reality (XR) application and operate in conjunction with a head-mounted display (HMD) configured to (i) receive, from the user terminal, an XR content via the XR application, (ii) detect a user interaction including at least one of a pupil movement, a hand motion, and a voice command, (iii) provide the detected motion or voice to the user terminal, and (iv) display the XR contents and the user interaction within a user's field of view. The virtual control method can include recognizing (i) a gaze gesture from the pupil movement and (ii) a Fleming gesture, an arm rotation gesture, a fist gesture, and a finger gesture from the hand motion, setting a gesture command for controlling a virtual object on the XR content based on transition of a window view, an immersive view, and a fully immersive view, and performing a virtual object control that includes movement, rotation, and a size change of the virtual object based on the gesture command.

In some implementations, performing the virtual object control can include performing, based on the gaze gesture for the virtual object being recognized for a predetermined time period in the gesture command, displaying of (i) emphasizing the virtual object selected by the gaze gesture and (ii) a user interface configured to receive a selected function for controlling the virtual object on the XR content, and the user interface can include a first sub-user interface configured to receive a selected function to move the virtual object, a second sub-user interface configured to receive a selected function to rotate the virtual object, and a third sub-user interface configured to receive a selected function to change a size of the virtual object. In some examples, performing the virtual object control can include, based on the Fleming gesture being recognized in the gesture command after the first sub-user interface is selected in the window view, distinguishing a left finger and a right finger of the hand in the Fleming view, displaying a movement axis for movement of the virtual object on the XR content, and setting a movement mode of the virtual object to an axis-fixed movement mode, in the axis-fixed movement mode, based on the arm rotation gesture being recognized after the Fleming gesture is recognized, moving the virtual object along the movement axis by a distance determined according to a degree of arm rotation, and, based on the fist gesture or the finger gesture being recognized, terminating the movement of the virtual object.

In some implementations, performing the virtual object control can further include, based on the Fleming gesture being recognized in the gesture command after the second sub-user interface is selected in the window view, distinguishing a left finger and a right finger of the hand in the Fleming view, displaying a rotation axis for rotation of the virtual object on the XR content, and setting a rotation mode of the virtual object to an axis-fixed rotation mode, in the axis-fixed rotation mode, based on the arm rotation gesture being recognized after the Fleming gesture is recognized, rotating the virtual object on the rotation axis by a distance determined by a degree of arm rotation, and, based on the fist gesture or the finger gesture being recognized, terminating the rotation of the virtual object. In some implementations, performing the virtual object control can further include recognizing a finger pinch gesture or a two-hand pinch gesture from the hand motion, based on the picking gesture being recognized in the gesture command after the first sub-user interface is selected in the immersive view, displaying an expected drop point of the virtual object on the XR content using a virtual grid, based on the drop gesture being recognized after the picking gesture is recognized, moving the virtual object to be dropping on the expected drop point, recognizing an axis rotation gesture from the hand motion, based on the Fleming gesture being recognized in the gesture command after the second sub-user interface is selected in the window view, distinguishing a left finger and a right finger of the hand in the Fleming view and displaying a rotation axis for rotation of the virtual object on the XR content, and, based on the axis rotation gesture being recognized after the Fleming gesture is recognized, rotating the virtual object on the rotation axis to correspond to the axis rotation.

In some implementations, performing the virtual object control can further include recognizing a finger pinch gesture or a two-hand pinch gesture from the hand motion, and, based on the finger pinch gesture or the two-hand pinch gesture being recognized in the gesture command after the third sub-user interface is selected in the immersive view, changing a size of the virtual object. In some examples, performing the virtual object control can further include recognizing a push wall gesture or a pull rope gesture from the hand motion, based on the push wall gesture or the pull rope gesture being recognized in the gesture command after the first sub-user interface or the second sub-user interface is selected in the fully immersive view, moving or rotating the virtual object, recognizing a compression gesture or an expansion gesture from the hand motion, and, based on the compression gesture or the expansion gesture being recognized in the gesture command after the third sub-user interface is selected in the fully immersive view, changing a size of the virtual object.

### BRIEF DESCRIPTION OF THE DRAWINGS

FIG. 1 is a diagram illustrating an example of a virtual object control system.

FIGS. 2-17 are diagrams illustrating an implementation example of a virtual object control system.

FIG. 18 is a diagram illustrating an example of a virtual object control method.

FIG. 19 is a diagram illustrating an example of a computing device.

### DETAILED DESCRIPTION

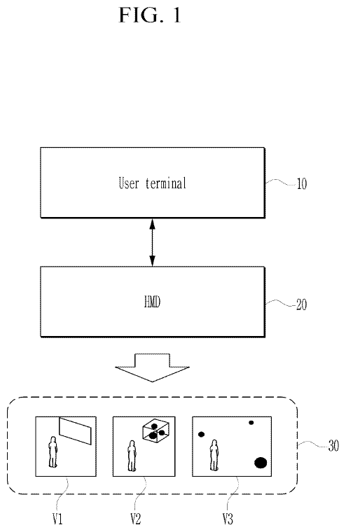

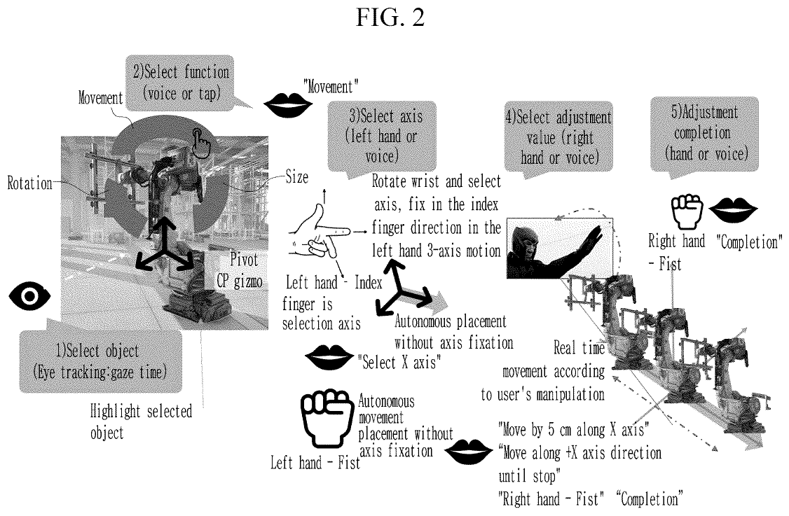

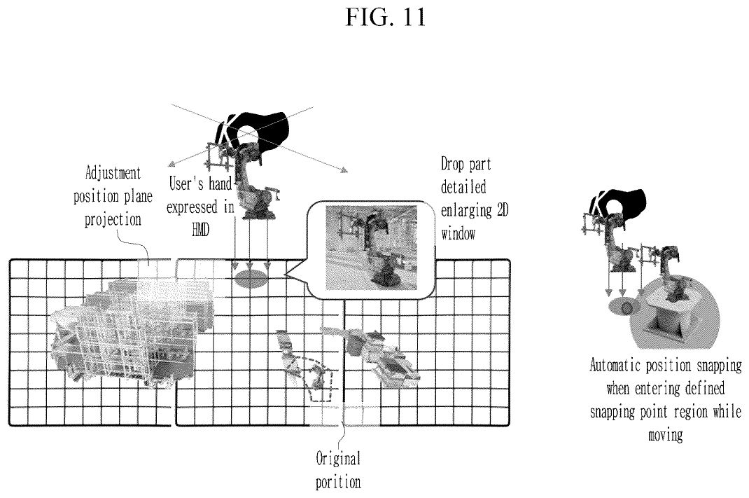

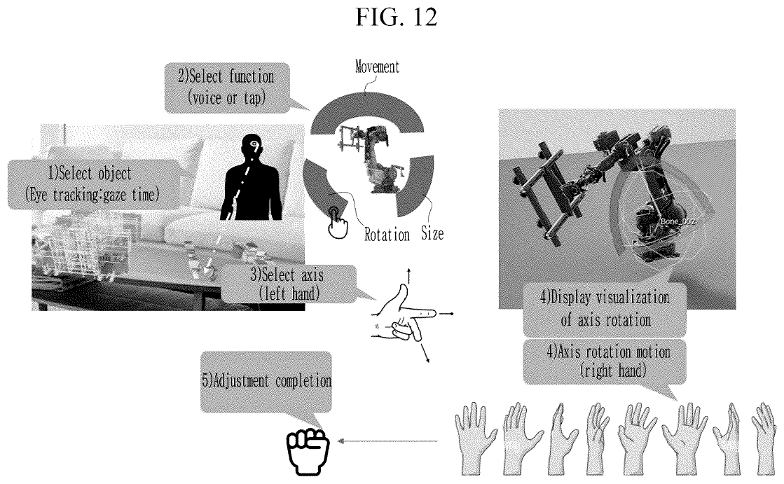

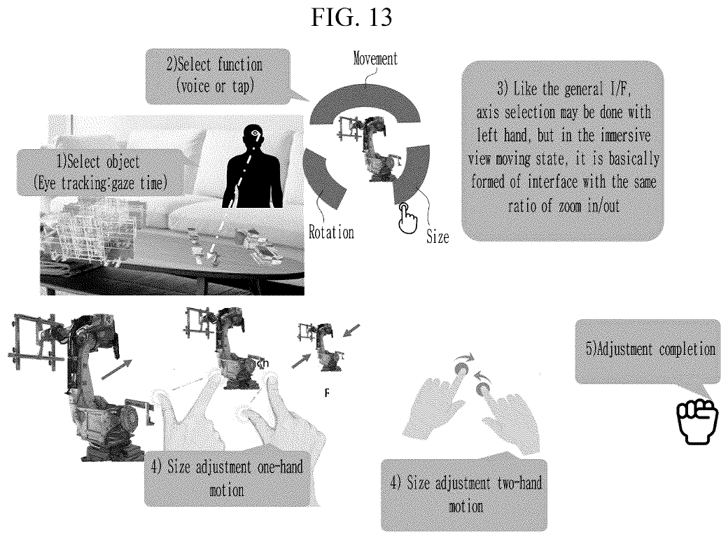

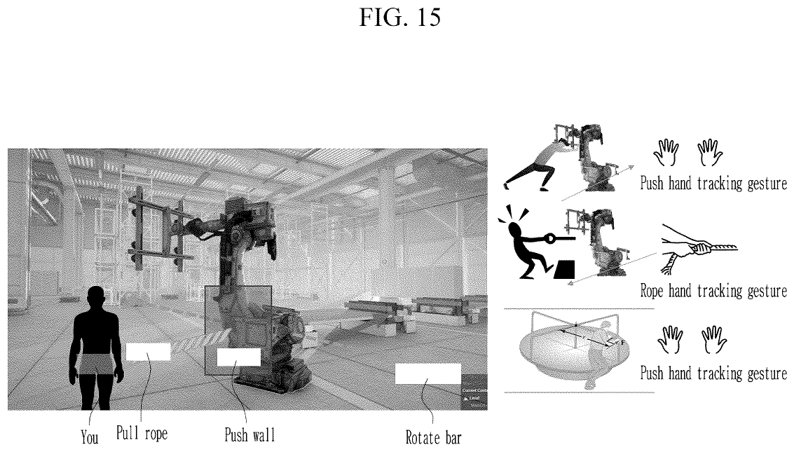

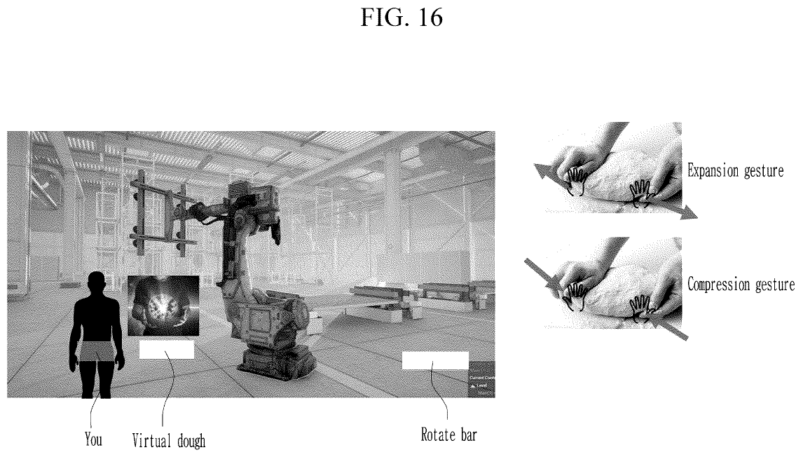

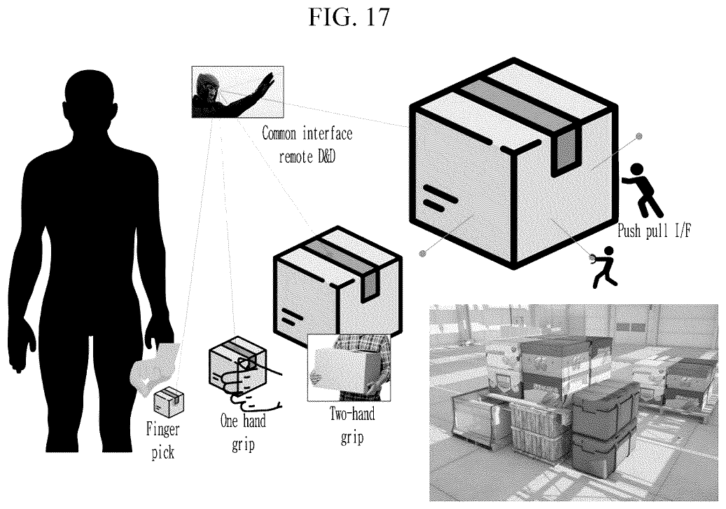

FIG. 1 is a diagram illustrating an example of a virtual object control system, and FIGS. 2-17 are diagrams illustrating an implementation example of a virtual object control system.

Referring to FIG. 1, a virtual object control system can include a user terminal 10 and a head-mounted display (HMD) 20. The user terminal 10 can be a mobile device, for example, a smartphone that can execute a virtual object control application and that can be carried by a user. An HMD can be a wearable device that the user wears on his/her head and that can provide a display screen in front of user's eye. The HMD can be used in virtual reality (VR), augment reality (AR), and eXtended reality (XR) environments.

In some implementations, the HMD can provide a user with an immersive 3D visual experience through a display, and can track movement of user's head using a built-in sensor (e.g., a gyroscope, an accelerometer, and the like) and can reflect the movement on the screen in real time. Some HMDs can enable interactions with the external environment through a camera and tracking technology, and can also provide content that combines reality and virtuality through a passthrough function. The virtual objection application executed in the user terminal 10 can operate in conjunction with the HMD 20.

For example, an XR application can be executed in the user terminal 10, and the HMD 20 can receive XR contents through the XR application from the user terminal 10, detect the user's eye movement, hand movement, and voice, provide the detected information to the user terminal 10, and display the user's interaction with the XR content in the field of view.

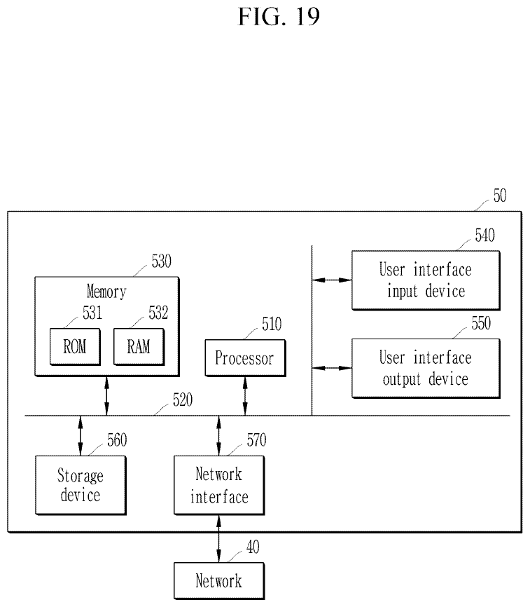

The XR application can be implemented in the user terminal 10, or can be implemented in an external server and implemented to be linked with the user terminal 10. A processor of the user terminal 10 or a processor of the external server can execute the XR application by executing a program code or instruction embedded in a memory device. For example, the user terminal 10 or the external server can be implemented as a computing device 50, as described with respect to FIG. 19.

In some implementations, the processor of the user terminal 10 or the processor of the external server can correspond to a processor 510 of the computing device 50, and a memory of the user terminal 10 or a memory of the external server can correspond to a memory 520. The program code or the instruction can be executed by the processor of the user terminal 10 or the processor of the external server, and thus can provide a function for virtual object control. Hereinafter, for the sake of clarity and convenience of description, it is described that the XR application performs a certain action, but it should be noted that this expression, in terms of implementation, refers that the processor of the user terminal 10 or the processor of the external server performs the action through the XR application.

The XR application can recognize predetermined various types of gestures. Specifically, the XR application can recognize a gaze gesture from a pupil motion of a user, and can recognize a Fleming gesture, an arm rotation gesture, a fist gesture, and a finger gesture from a hand motion of the user.

The gaze gesture can refer to a gesture that selects a specific object or executes a command based on the pupil motion of the user. For example, when the user moves the pupil to a specific direction or gazes a specific object, selection or a command for the corresponding direction or object can be performed. The Fleming gesture can refer to a gesture that shapes Fleming's left-hand rule or right-hand rule with hand motion, and can perform a specific command or indicate a direction through the arrangement of fingers (the thumb, index finger, and middle finger are spread out at right angles to each other).

The arm rotation gesture can refer to a gesture that controls a change in a specific command or object by the user rotating his/her arm, the fist gesture can refer to a gesture that activates a specific command or performs a grab action by making a fist with his/her hand, and the finger gesture can refer to a gesture that performs a command through the motion of a finger or the action of opening or closing a specific finger.

The XR application can be configured to provide different gesture commands for controlling a virtual object on XR contents depending on the transition between a window view V1, an immersive view V2, and a fully immersive view V3. Here, the gesture command can be executed by the XR application to move, rotate, or resize the virtual object.

The window view V1 can provide a way to experience the virtual environment through a limited field of view, as if looking through a window. The user can observe the virtual world or perform specific tasks through the display, and interaction may be limited. The immersive view V2 can be a method that provides an experience where the user is immersed in a virtual environment and becomes a part of that environment, and can provide a high level of immersion by allowing the user's head motion and interaction to be reflected in real time and the virtual world to be searched in 360 degrees. The fully immersive view can be a method that provides an experience where multiple users can immerse themselves in the same virtual environment and interact with each other, and multiple users can access the same virtual space through their own devices (e.g., HMD) and collaborate or interact with each other.

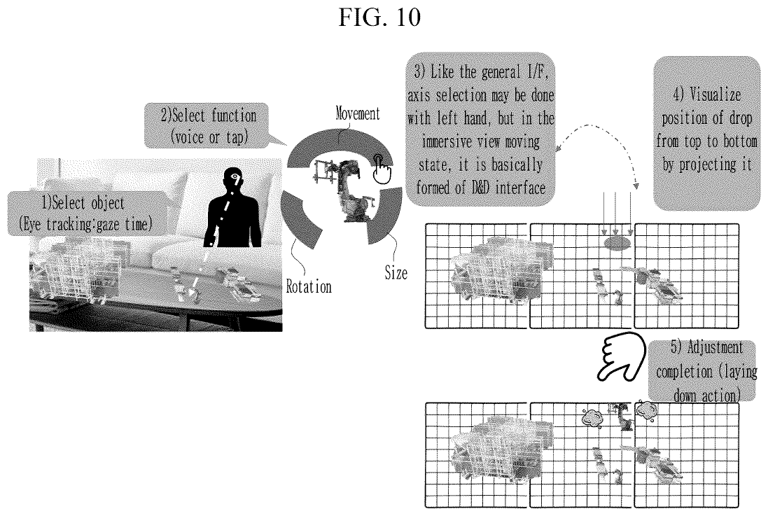

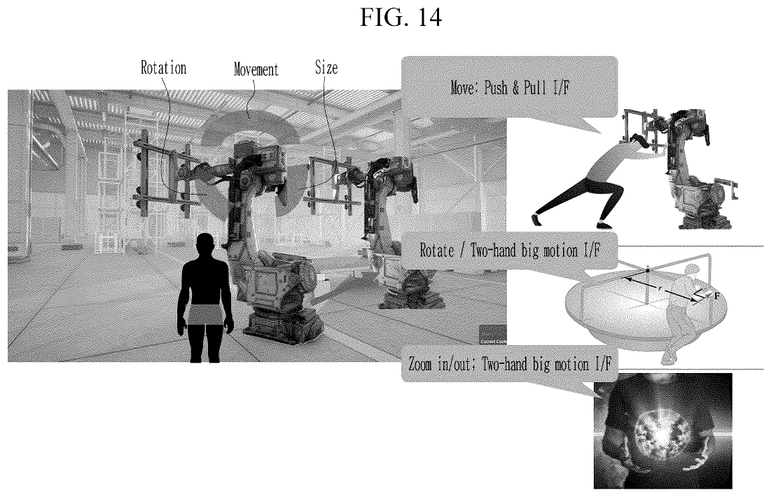

Hereinafter, the virtual object control system will be described with respect to FIGS. 2-17. FIGS. 2-9 are diagrams illustrating an implementation example for a window view, FIGS. 10-13 are diagrams illustrating an implementation example of an immersive view, and FIGS. 14-17 are diagrams illustrating an implementation example of a fully immersive view.

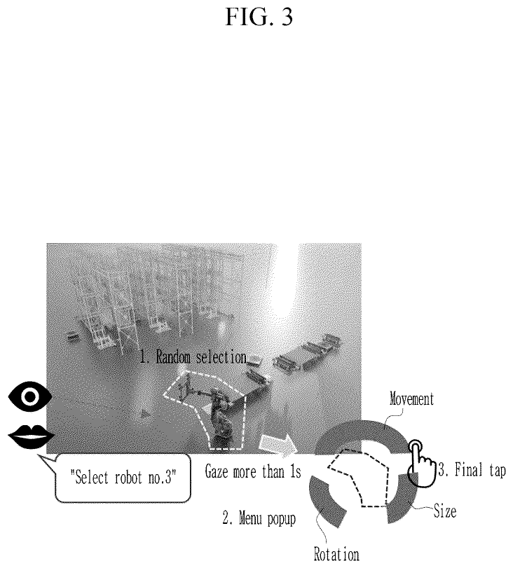

Referring to FIGS. 2-3, when the gaze gesture is recognized for a predetermined time period (e.g., one section) for a virtual object in the gesture command, the XR application can display the virtual object selected through the gaze gesture for emphasizing the virtual object. In addition, the XR application can perform displaying of a user interface for selection of a detailed function for the user to manipulate the virtual object.

Here, the user interface can include a first sub-user interface, a second sub-user interface, and a third sub-user interface. The first sub-user interface can be a sub-user interface for selecting a function to move the virtual object, and the second sub-user interface can be a sub-user interface for selecting a function to rotate the virtual object. The third sub-user interface can be a sub-user interface for selecting a function to change the size of the virtual object.

When the Fleming gesture is recognized from the gesture command after the first sub-user interface is selected in the window view, the XR application can identify the left finger and the right finger of the user's hand to display a movement shaft for the movement of the virtual object on the XR contents. within view of this, the XR application can obtain a movement mode of the virtual object as an axis-fixed movement mode. Here, the axis-fixed movement mode can indicate a mode for the virtual object to move along a shaft selected by the Fleming gesture.

In some implementations, when the fist gesture is recognized in the gesture command after the first sub-user interface is selected, the XR application can set the movement mode of the virtual object to an autonomous movement mode. Here, the autonomous movement mode can indicate a mode for the virtual object to move in a random direction without restriction to follow the axis.

When the arm rotation gesture is recognized after the Fleming gesture is recognized in the axis-fixed movement mode, the XR application can move the virtual object on the movement shaft by a distance determined according to the amount of arm rotation. In some implementations, when the fist gesture or finger gesture is recognized after the Fleming gesture is recognized in the axis-fixed movement mode, the XR application may terminate the movement of the virtual object.

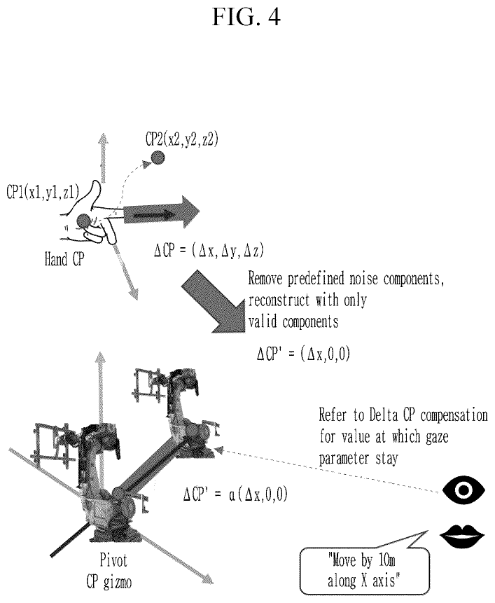

Referring to FIG. 4, the left hand is used as a parameter that represents three axes of the orthogonal coordinates according to the Fleming's left hand rule, and shaft fixation can be performed by recognizing a center coordinate (CP) value of the left hand. In this process, coordinate values can be respectively determined as Δx, Δy, and Δz, an operation can be applied according to the following conditions. First, a change in a CP value of the hand can be extracted and calculated by compensating the HMD motion rather than the hand motion. After that, an axis having the largest variable value can be selected, and other components may be regarded as noise and excluded. If there is a range with a similar Δ value, movement in two axes can be allowed. Finally, only ΔCP′xa value, which is adjusted according to a sensitivity adjustment constant a, the compensated ΔCP value, can be reflected in the actual movement amount. This method can enable precise control by accurately tracking hand motion while minimizing unnecessary noise.

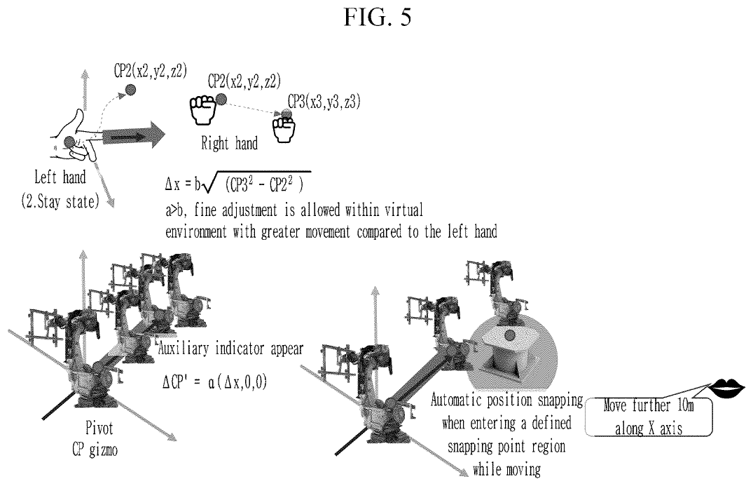

Referring to FIG. 5, the XR application can perform fine-adjusting by additionally moving the virtual object along the movement axis by a distance determined by the fist gesture when the arm rotation gesture is recognized in the fixed-axis movement mode, and the Fleming gesture and fist gesture can be recognized together. That is, in the state of FIG. 4, when the right hand appears while the left hand pose is maintained without a separate completion signal, a fine-adjusting function can be activated. In this case, since the axis is already fixed, the movement value of the right hand itself can be applied as a fine adjustment amount. A movement value of the right hand can be adjusted by an adjustment constant b, which is set to a value less than a, allowing fine position changes within the virtual environment to be specified through relatively large motions of the right hand. This method can allow for precise manipulation by the user and may be advantageous for performing precise work within a virtual environment.

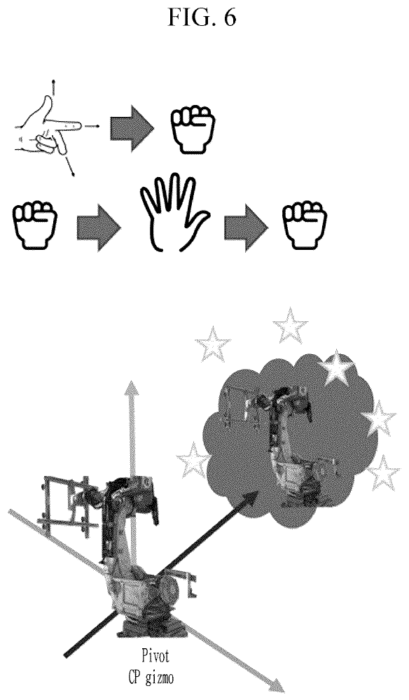

Referring to FIG. 6, a hand tracking gesture is shown to confirm the adjusted object position. The user can perform a simple and intuitive confirmation action through a finger gesture such as making a fist with his/her right or left hand or opening and closing his/her hand again. In some implementations, a hand gesture can be used for cancellation or reversal of cancellation. The system can enable cancellation or restoration to the previous state when the user moves the hand in a specific direction, and the previous or next step can be adjusted depending on the direction of the hand.

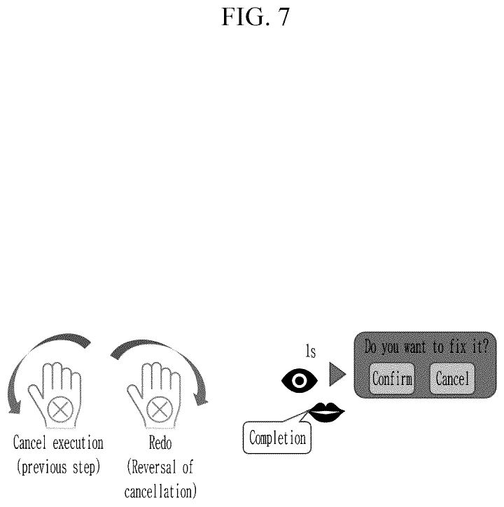

Referring to FIG. 7, when the gaze value is maintained for a certain period of time, an additional command can be performed by displaying a pop-up menu using a look & tap method. In addition, a method of auxiliary execution of the “complete” or “cancel” command can be provided through a voice recognition function.

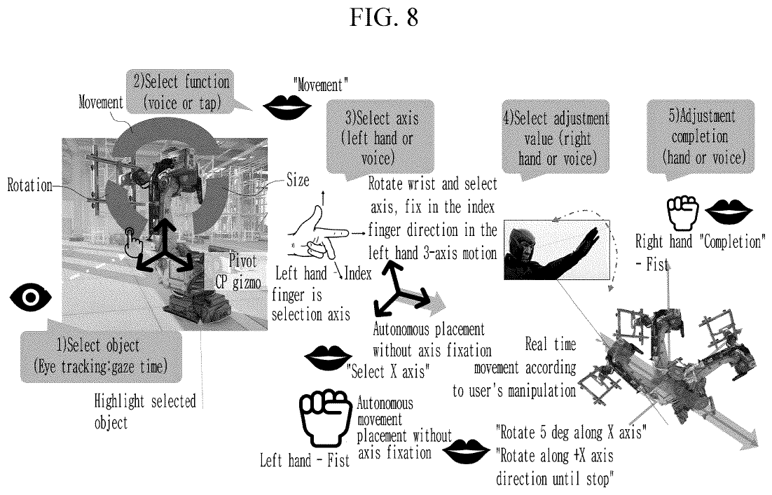

Referring to FIG. 8, when a Fleming gesture is recognized in the gesture command after the second sub-user interface is selected in the window view, the XR application can display a rotation axis for the rotation of the virtual object on the XR contents by distinguishing the left and right of the hand and fingers in the Fleming gesture, and set the rotation mode of the virtual object to the axis-fixed rotation mode. Here, the axis-fixed rotation mode can refer to a mode in which the virtual object rotates around the axis selected by the Fleming gesture.

In some implementations, when the fist gesture is recognized in the gesture command after the first sub-user interface is selected, the XR application can set the rotation mode of the virtual object to the autonomous rotation mode. The autonomous rotation mode can refer to a mode in which the virtual object rotates in any direction without being restricted to centering on an axis.

When the arm rotation gesture is recognized after the Fleming gesture is recognized in the fixed-axis rotation mode, the XR application can rotate the virtual object on the rotation axis by a distance determined according to the degree of arm rotation. In some implementations, when the first gesture or finger gesture is recognized after the Fleming gesture is recognized in the axis-fixed rotation mode, the rotation of the virtual object may be terminated.

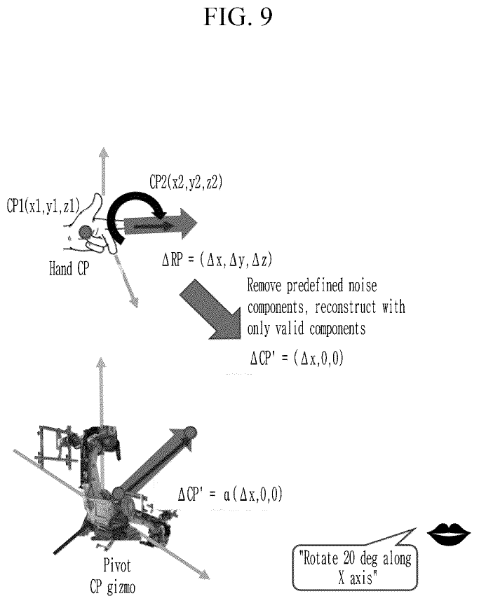

Referring to FIG. 9, the left hand can be used as a parameter representing the three axes of the orthogonal coordinate system according to Fleming's left-hand rule, and the axis can be fixed by recognizing the center coordinate CP of the left hand. In this case, the respective coordinate values can be defined as Δx, Δy, and Δz, and the following operation rule can be applied. First, the motion of the HMD, not the motion of the hand, can be compensated for and only the CP value change of the hand can be extracted and calculated. After that, one axis with the largest value can be selected from among the Δ values, and the remaining components can be regarded as noise and thus excluded. In addition, for rotation, unlike for movement, only one axis can be specified and processed. This process can reduce unnecessary data interference and enable precise motion control.

Referring to FIGS. 10-13, which correspond to the immersive view, the XR application can additionally recognize a picking gesture and a drop gesture from the user's hand motion. When the picking gesture is recognized in the gesture command after the first sub-user interface is selected in the immersive view, the XR application can display an expected drop point of the virtual object on the XR contents using a virtual grid, and when the drop gesture is recognized after the recognition of the picking gesture, the XR application can move the virtual object to drop on the expected drop point.

When moving the virtual object such that the virtual object drops on the expected drop point, the XR application can perform a snap to a designated object within a snap region if the position of the virtual object after the movement falls within a predetermined snap region.

The XR application can additionally recognize an axis rotation gesture from the user's hand motion. When a Fleming gesture is recognized in the gesture command after the second-sub user interface is selected in the immersive view, the XR application can display a rotation axis for the rotation of the virtual object on the XR contents by distinguishing the left finger and the right finger of the hand from the Fleming gesture, and when the axis rotation gesture is recognized after the Fleming gesture is recognized, the XR application can rotate the virtual object on the rotation axis so as to correspond to the axis rotation.

The XR application can additionally recognize a finger pinch gesture or a two-hand pinch gesture from the user's hand motion, and change the size of the virtual object when the finger pinch gesture or the two-hand pinch gesture is recognized in the gesture command after the third sub-user interface is selected in the immersive view.

Referring to FIGS. 14-17, which correspond to the fully immersive view, the XR application can additionally recognize a push wall gesture or a push rope gesture from the user's hand motion, and, when the push wall gesture or the push rope gesture is recognized after the first sub-user interface or the second sub-user interface is selected in the fully immersive view, the XR application can move or rotate the virtual object.

The XR application can additionally recognize a compression gesture or an expansion gesture from the user's hand motion, and, when the compression gesture or the expansion gesture is recognized after the third-sub user interface is selected in the fully immersive view, the XR application can change the size of the virtual object.

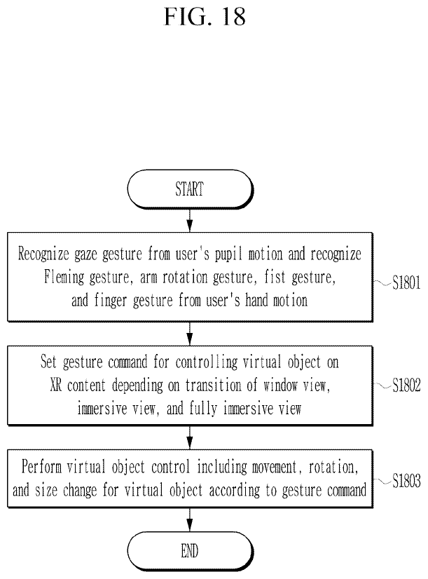

FIG. 18 is a diagram illustrating an example of a virtual object control method.

Referring to FIG. 18, a virtual object control method can may perform recognition of a gaze gesture from a user's pupil movement, and a Fleming gesture, an arm rotation gesture, a fist gesture, and a finger gesture from a user's hand motion (S1801), setting to change a gesture command for controlling a virtual object on XR contents to be changed depending on the transition between a window view, an immersive view, and a fully immersive view (S1802), and performing a virtual object control including movement, rotation, and size change for the virtual object according to the gesture command (S1803).

For more detailed information about the method, refer to the description of another implementation included in this specification, and therefore a redundant description is omitted.

FIG. 19 is a diagram illustrating an example of a computing device.

Referring to FIG. 19, a virtual object control system and a method thereof can be implemented by using a computing device 50. The computing device 50 can be implemented as various types of electronic devices, a server, or a device similar thereto, and functions of the computing device 50 may be implemented through combination of software and hardware.

The computing device 50 can include at least one of a processor 510 communicating through a bus 520, a memory 530, a user interface input device 540, a user interface output device 550, and a storage device 560. The computing device 50 can also include a network interface 570 that is electrically connected to the network 40. The network interface 570 can transmit or receive a signal with other medium through the network 40.

The processor 510 can be a micro controller unit (MCU), an application processor (AP), a central processing unit (CPU), a graphic processing unit (GPU), a neural processing unit (NPU), a quantum processing unit (QPU), and the like. The processor 510 can be a semiconductor device that executes a command stored in the memory 530 or the storage device 560, and can perform a key role of the system. A program code and data stored in the memory 530 or the storage device 560 can instruct the processor 510 to perform a specific work, thereby enabling the overall operation of the system. The processor 510 can be formed to implement the various functions and methods described above with reference to FIGS. 1-19 through the program code and data.

The memory 530 and the storage device 560 can include various types of volatile or non-volatile storage medium for data storage and access of the system. For example, the memory 530 can include a read-only memory (ROM) 531 and a random access memory (RAM) 532. In some implementations, the memory 530 can be embedded in the processor 510, and, in this case, data transmission speed between the memory 530 and the processor 510 may be very fast. In some implementations, the memory 530 can be disposed outside the processor 510, and, in this case, the memory 530 can be connected with the processor 510 through various data buses or interfaces. Such a connection can be made by a variety of means already known, for example, via a peripheral component interconnect express (PCIe) interface for high-rate data transmission or via a memory controller.

In some implementations, at least some components or functions of the virtual object control system and method can be implemented as a program or software executing on the computing device 50, and the program or software can be stored on a computer-readable recording medium or storage medium. Specifically, a computer-readable recording medium or storage medium can record a program to execute steps involved in implementing the virtual object control system and method in a computer including the memory 530 or the storage device 560 that executes the program or command stored therein.

In some implementations, at least some components or functions of the virtual object control system and method can be implemented using hardware or circuitry of the computing device 50, or can be implemented as separate hardware or circuitry that can be electrically connected to the computing device 50.

In some implementations, an application provided with a camera viewpoint switching function that is common on the HMD is provided, and can include a function that can adjust a virtual environment background/UI and the scale of and a virtual object. When selecting an object that requires size adjustment within a virtual environment, the object's size adjustment can be performed according to a predefined eye tracking and hand tracking method to match the real-world consistency. Additionally, the process of selecting, moving, and dropping an object on the screen within the range where the biometric tracking function operates is clearly provided in a visual representation. This process is designed to allow a user to perform work intuitively, which greatly improves the efficiency and accuracy of object manipulation within the virtual environment and greatly improves the convenience of work and user experience within the virtual environment.

What is claimed is:

1. A virtual object control system comprising:
a user terminal configured to execute an eXtended reality (XR) application; and
a head-mounted display (HMD) configured to:
receive, from the user terminal, an XR content via the XR application,
detect a user interaction including at least one of a pupil movement, a hand motion, or a voice command, and
provide, to the user terminal, the detected user interaction, and
display the XR content and the user interaction within a user's field of view,
wherein the XR application is configured to:
recognize (i) a gaze gesture from the pupil movement and (ii) a Fleming gesture, an arm rotation gesture, a fist gesture, and a finger gesture from the hand motion, and
set a gesture command for controlling a virtual object on the XR content based on transition of a window view, an immersive view, and a fully immersive view, and
wherein the gesture command is executed by the XR application to move the virtual object, rotate the virtual object, or change a size of the virtual object.

2. The virtual object control system of claim 1, wherein:
the XR application is configured to, based on the gaze gesture being recognized for a predetermined time period for the virtual object in the gesture command, perform displaying of (i) emphasizing the virtual objected selected by the gaze gesture and (ii) a user interface configured to receive a selected function for controlling the virtual object on the XR content, and
the user interface comprises:
a first sub-user interface configured to receive a selected function to move the virtual object,
a second sub-user interface configured to receive a selected function to rotate the virtual object, and
a third sub-user interface configured to receive a selected function to change a size of the virtual object.

3. The virtual object control system of claim 2, wherein:
the XR application is configured to, based on the Fleming gesture being recognized in the gesture command after the first sub-user interface is selected in the window view, distinguish a left finger and a right finger of the hand in the Fleming gesture, display a movement axis for movement of the virtual object on the XR content, and set a movement mode of the virtual object to an axis-fixed movement mode, and
the XR application is configured to, based on the fist gesture being recognized in the gesture command after the first sub-user interface is selected, set the movement mode of the virtual object to an autonomous movement mode.

4. The virtual object control system of claim 3, wherein:
the XR application is configured to, based on the arm rotation gesture being recognized after the Fleming gesture is recognized in the axis-fixed movement mode, move the virtual object along the axis of movement by a distance determined by a degree of rotation, and
the XR application is configured to, based on the fist gesture or the finger gesture being recognized, terminate the movement of the virtual object.

5. The virtual object control system of claim 4, wherein:
the XR application is configured to, based on the Fleming gesture and the fist gesture being recognized together after the arm rotation gesture is recognized in the axis-fixed movement mode, move the virtual object along the axis of movement by a distance determined according to the fist gesture.

6. The virtual object control system of claim 2, wherein:
the XR application is configured to, based on the Fleming gesture being recognized in the gesture command after the second sub-user interface is selected in the window view, distinguish a left finger and a right finger of the hand in the gesture command, display a rotation axis for rotation of the virtual object on the XR content, and set a rotation mode of the virtual object to an axis-fixed rotation mode, and
the XR application is configured to, based on the fist gesture being recognized in the gesture command after the first sub-user interface is selected, set a rotation mode of the virtual object to an autonomous rotation mode.

7. The virtual object control system of claim 6, wherein:
the XR application is configured to, based on the arm rotation gesture being recognized after the Fleming gesture is recognized in the axis-fixed rotation mode, rotate the virtual object along the rotation axis by a distance determined according to a degree of arm rotation, and
the XR application is configured to, based on the fist gesture or the finger gesture being recognized, terminate the rotation of the virtual object.

8. The virtual object control system of claim 2, wherein:
the XR application is configured to recognize a picking gesture and a drop gesture from the hand motion,
the XR application is configured to, based on the picking gesture being recognized in the gesture command after the first sub-user interface is selected in the immersive view, display an expected drop point on the XR content using a virtual grid, and
the XR application is configured to, based on the drop gesture being recognized after the picking gesture is recognized, move the virtual object to drop the virtual object on the expected drop point.

9. The virtual object control system of claim 8, wherein:
the XR application is configured to, based on the virtual object being moved to be dropped on the expected drop point, perform a snap for a designated object in a predetermined snap region when a position of the virtual object after the movement is included in the predetermined snap region.

10. The virtual object control system of claim 2, wherein:
the XR application is configured to recognize an axis rotation gesture from the hand motion, and
the XR application is configured to, based on the Fleming gesture being recognized in the gesture command after the second sub-user interface is selected in the immersive view, distinguish a left finger and a right finger of the hand in the Fleming gesture and display a rotation axis for rotation of the virtual object on the XR content, and
the XR application is configured to, based on the axis rotation gesture being recognized after the Fleming gesture is recognized, rotate the virtual object on the rotation axis to correspond to the axis rotation.

11. The virtual object control system of claim 2, wherein:
the XR application is configured to recognize a finger pinch gesture or a two-hand pinch gesture from the hand motion, and
the XR application is configured to, based on the finger pinch gesture or the two-hand pinch gesture being recognized in the gesture command after the third sub-user interface is selected in the immersive view, change a size of the virtual object.

12. The virtual object control system of claim 2, wherein:
the XR application is configured to recognize a push wall gesture or a pull rope gesture from the hand motion, and
the XR application is configured to, based on the push wall gesture or the pull rope gesture being recognized in the gesture command after the first sub-user interface or the second sub-user interface is selected in the fully immersive view, move or rotate the virtual object.

13. The virtual object control system of claim 2, wherein:
the XR application is configured to recognize a compression gesture or an expansion gesture from the hand motion, and
the XR application is configured to, based on the compression gesture or the expansion gesture being recognized after the third sub-user interface is selected in the fully immersive view, change a size of the virtual object.

14. A virtual object control method performed by a user terminal, which is configured to execute an eXtended reality (XR) application and operate in conjunction with a head-mounted display (HMD) configured to (i) receive, from the user terminal, an XR content via the XR application, (ii) detect a user interaction including at least one of a pupil movement, a hand motion, and a voice command, (iii) provide the detected user interaction to the user terminal, and (iv) display the XR contents and the user interaction within a user's field of view, the virtual control method comprising:
recognizing (i) a gaze gesture from the pupil movement and (ii) a Fleming gesture, an arm rotation gesture, a fist gesture, and a finger gesture from the hand motion;
setting a gesture command for controlling a virtual object on the XR content based on transition of a window view, an immersive view, and a fully immersive view; and
performing a virtual object control that includes movement, rotation, and a size change of the virtual object based on the gesture command.

15. The virtual object control method of claim 14, wherein:
performing the virtual object control comprises performing, based on the gaze gesture for the virtual object being recognized for a predetermined time period in the gesture command, displaying of (i) emphasizing the virtual object selected by the gaze gesture and (ii) a user interface configured to receive a selected function for controlling the virtual object on the XR content, and
the user interface comprises:
a first sub-user interface configured to receive a selected function to move the virtual object;
a second sub-user interface configured to receive a selected function to rotate the virtual object; and
a third sub-user interface configured to receive a selected function to change a size of the virtual object.

16. The virtual object control method of claim 15, wherein:
performing the virtual object control further comprises:
based on the Fleming gesture being recognized in the gesture command after the first sub-user interface is selected in the window view, distinguishing a left finger and a right finger of the hand in the Fleming view, displaying a movement axis for movement of the virtual object on the XR content, and setting a movement mode of the virtual object to an axis-fixed movement mode;
in the axis-fixed movement mode, based on the arm rotation gesture being recognized after the Fleming gesture is recognized, moving the virtual object along the movement axis by a distance determined according to a degree of arm rotation; and
based on the fist gesture or the finger gesture being recognized, terminating the movement of the virtual object.

17. The virtual object control method of claim 15, wherein:
performing the virtual object control further comprises:
based on the Fleming gesture being recognized in the gesture command after the second sub-user interface is selected in the window view, distinguishing a left finger and a right finger of the hand in the Fleming view, displaying a rotation axis for rotation of the virtual object on the XR content, and setting a rotation mode of the virtual object to an axis-fixed rotation mode;
in the axis-fixed rotation mode, based on the arm rotation gesture being recognized after the Fleming gesture is recognized, rotating the virtual object on the rotation axis by a distance determined by a degree of arm rotation; and
based on the fist gesture or the finger gesture being recognized, terminating the rotation of the virtual object.

18. The virtual object control method of claim 15, wherein:
performing the virtual object control further comprises:
recognizing a finger pinch gesture or a two-hand pinch gesture from the hand motion;
based on a picking gesture being recognized in the gesture command after the first sub-user interface is selected in the immersive view, displaying an expected drop point of the virtual object on the XR content using a virtual grid;
based on a drop gesture being recognized after the picking gesture is recognized, moving the virtual object to be dropping on the expected drop point;
recognizing an axis rotation gesture from the hand motion;
based on the Fleming gesture being recognized in the gesture command after the second sub-user interface is selected in the window view, distinguishing a left finger and a right finger of the hand in the Fleming view and displaying a rotation axis for rotation of the virtual object on the XR content; and
based on the axis rotation gesture being recognized after the Fleming gesture is recognized, rotating the virtual object on the rotation axis to correspond to the axis rotation.

19. The virtual object control method of claim 15, wherein:
performing the virtual object control further comprises:
recognizing a finger pinch gesture or a two-hand pinch gesture from the hand motion; and
based on the finger pinch gesture or the two-hand pinch gesture being recognized in the gesture command after the third sub-user interface is selected in the immersive view, changing a size of the virtual object.

20. The virtual object control method of claim 15, wherein:
performing the virtual object control further comprises:
recognizing a push wall gesture or a pull rope gesture from the hand motion;
based on the push wall gesture or the pull rope gesture being recognized in the gesture command after the first sub-user interface or the second sub-user interface is selected in the fully immersive view, moving or rotating the virtual object;
recognizing a compression gesture or an expansion gesture from the hand motion; and
based on the compression gesture or the expansion gesture being recognized in the gesture command after the third sub-user interface is selected in the fully immersive view, changing a size of the virtual object.
